(19) United States
(12) Patent Application Publication
(10) Pub. No.: US 2024/0419939 A1
(43) Pub. Date: Dec. 19, 2024

(54) System, Method, and Computer Program Product for Determining Long-Range Dependencies Using a Non-Local Graph Neural Network (GNN)

(71) Applicant: Visa International Service Association, San Francisco, CA (US)

(72) Inventors: Huiyuan Chen, San Jose, CA (US); Michael Yeh, Newark, CA (US); Fei Wang, Fremont, CA (US); Hao Yang, San Jose, CA (US)

(21) Appl. No.: 18/702,960

(22) PCT Filed: Oct. 20, 2022
(86) PCT No.: PCT/US2022/047234

§ 371 Date: Apr. 19, 2024

Related U.S. Application Data
(60) Provisional application No. 63/270,103, filed on Oct. 21, 2021.

(51) Int. Cl. G06N 3/042; G06N 3/0464

(52) U.S. Cl. CPC G06N 3/042; G06N 3/0464

(57) ABSTRACT

Systems, methods, and computer program products for determining long-range dependencies using a non-local graph neural network (GNN): receive a dataset comprising historical data; generate at least one layer of a graph neural network by generating graph convolutions to compute node embeddings for a plurality of nodes of the dataset, the graph convolutions generated by aggregating node data from a first node of the dataset and node data from at least one second node comprising a neighbor node of the first node; cluster the node embeddings to form a plurality of centroids; determine an attention operator for at least one node-centroid pairing, the at least one node-centroid pairing comprising the first node and a first centroid; and generate relational data corresponding to a relation between the first node and at least one third node comprising a non-neighbor node of the first node using the attention operator.

### CROSS-REFERENCE TO RELATED APPLICATIONS

This application is the United States national phase of International Application No. PCT/US2022/047234 filed Oct. 20, 2022, and claims priority to U.S. Provisional Patent Application No. 63/270,103, filed on Oct. 21, 2021, the disclosures of which are incorporated by reference herein in their entireties.

### BACKGROUND

### 1. Technical Field

This disclosure relates generally to determining long-range dependencies using machine-learning and, in particular embodiments, to a system, method, and computer program product for determining long-range dependencies using a non-local graph neural network (GNN).

### 2. Technical Considerations

Recommendation systems are designed to aid users by generating recommendations believed to be relevant to the user based on historical data. Machine learning algorithms, such as graph neural networks (GNN), may be used to process historical data to determine relationships among the data parameters and generate recommendations for the user. The relationships include long-range dependencies between parameters contained in the data, which long-range dependencies can be determined by running the GNN to several depths. Conventional methods of employing GNNs can only identify these long-range dependencies by allowing the GNN to run to several depths, which consumes vast amounts of time and computer processing resources and can sacrifice the integrity of the output by over-fitting or over-smoothing the data. Determining long-range dependencies without requiring deep depths of the GNN to be run would be desirable.

### SUMMARY

According to non-limiting embodiments or aspects, provided is a method for determining long-range dependencies using a non-local graph neural network that includes: receiving, with at least one processor, a dataset including historical data; generating at least one layer of a graph neural network by generating, with at least one processor, graph convolutions to compute node embeddings for a plurality of nodes of the dataset, the graph convolutions generated by aggregating node data from a first node of the dataset and node data from at least one second node including a neighbor node of the first node; clustering, with at least one processor, the node embeddings to form a plurality of centroids, each centroid corresponding to a graph-level representation of a plurality of node embeddings, the plurality of centroids including a first centroid; determining, with at least one processor, an attention operator for at least one node-centroid pairing, the at least one node-centroid pairing including the first node and the first centroid, the attention operator configured to measure a similarity between the first node and the first centroid; and generating, with at least one processor, relational data corresponding to a relation between the first node and at least one third node including a non-neighbor node of the first node using the attention operator.

In non-limiting embodiments or aspects, the method may include generating, with at least one processor, a recommendation based on the relational data. The first node may correspond to a first user, where the historical data includes a plurality of first user-item pairings corresponding to historical transactions of the first user, where the method may further include: generating, with at least one processor, a first recommendation for the first user based on the relational data, the first recommendation including an item not directly associated with the first user in the historical data; and transmitting, with at least one processor, the first recommendation to a device of the first user. A plurality of layers of the graph neural network may be generated, where the clustering is performed in between each layer of the graph neural network generated, and each subsequent layer is generated using at least one centroid formed at a preceding layer. The attention operator may include a multi-headed attention. The method may further include generating, with at least one processor, based on the attention operator and the aggregated node data from the first node and the at least one second node including the neighbor node of the first node, a mixed embedding. The relational data may be generated based on the mixed embedding.

According to non-limiting embodiments or aspects, provided is a system for determining long-range dependencies using a non-local graph neural network including at least one processor programmed and/or configured to: receive a dataset including historical data; generate at least one layer of a graph neural network by generating graph convolutions to compute node embeddings for a plurality of nodes of the dataset, the graph convolutions generated by aggregating node data from a first node of the dataset and node data from at least one second node including a neighbor node of the first node; cluster the node embeddings to form a plurality of centroids, each centroid corresponding to a graph-level representation of a plurality of node embeddings, the plurality of centroids including a first centroid; determine an attention operator for at least one node-centroid pairing, the at least one node-centroid pairing including the first node and the first centroid, the attention operator configured to measure a similarity between the first node and the first centroid; and generate relational data corresponding to a relation between the first node and at least one third node including a non-neighbor node of the first node using the attention operator.

In non-limiting embodiments or aspects, the at least one processor may be programmed and/or configured to: generate a recommendation based on the relational data. The first node may correspond to a first user, where the historical data includes a plurality of first user-item pairings corresponding to historical transactions of the first user, where the at least one processor may be programmed and/or configured to: generate a first recommendation for the first user based on the relational data, the first recommendation including an item not directly associated with the first user in the historical data; and transmit the first recommendation to a device of the first user. A plurality of layers of the graph neural network may be generated where the clustering is performed in between each layer of the graph neural network generated, and each subsequent layer is generated using at least one centroid formed at a preceding layer. The attention operator may include a multi-headed attention. The at least one processor may be programmed and/or configured to: generate, based on the attention operator and the aggregated node data from the first node and the at least one second node including the neighbor node of the first node, a mixed embedding. The relational data may be generated based on the mixed embedding.

According to non-limiting embodiments or aspects, provided is a computer program product for determining long-range dependencies using a non-local graph neural network including at least one non-transitory computer-readable medium including program instructions that, when executed by at least one processor, cause the at least one processor to: receive a dataset including historical data; generate at least one layer of a graph neural network by generating graph convolutions to compute node embeddings for a plurality of nodes of the dataset, the graph convolutions generated by aggregating node data from a first node of the dataset and node data from at least one second node including a neighbor node of the first node; cluster the node embeddings to form a plurality of centroids, each centroid corresponding to a graph-level representation of a plurality of node embeddings, the plurality of centroids including a first centroid; determine an attention operator for at least one node-centroid pairing, the at least one node-centroid pairing including the first node and the first centroid, the attention operator configured to measure a similarity between the first node and the first centroid; and generate relational data corresponding to a relation between the first node and at least one third node including a non-neighbor node of the first node using the attention operator.

In non-limiting embodiments or aspects, the program instructions may cause the at least one processor to generate a recommendation based on the relational data. The first node may correspond to a first user, where the historical data includes a plurality of first user-item pairings corresponding to historical transactions of the first user, where the program instructions may cause the at least one processor to: generate a first recommendation for the first user based on the relational data, the first recommendation including an item not directly associated with the first user in the historical data; and transmit the first recommendation to a device of the first user. A plurality of layers of the graph neural network may be generated, where the clustering is performed in between each layer of the graph neural network generated, and each subsequent layer is generated using at least one centroid formed at a preceding layer. The attention operator may include a multi-headed attention. The program instructions may cause the at least one processor to: generate, based on the attention operator and the aggregated node data from the first node and the at least one second node including the neighbor node of the first node, a mixed embedding. The relational data may be generated based on the mixed embedding.

Further non-limiting embodiments or aspects are set forth in the following numbered clauses:

Clause 1: A method for determining long-range dependencies using a non-local graph neural network, comprising: receiving, with at least one processor, a dataset comprising historical data; generating at least one layer of a graph neural network by generating, with at least one processor, graph convolutions to compute node embeddings for a plurality of nodes of the dataset, the graph convolutions generated by aggregating node data from a first node of the dataset and node data from at least one second node comprising a neighbor node of the first node; clustering, with at least one processor, the node embeddings to form a plurality of centroids, each centroid corresponding to a graph-level representation of a plurality of node embeddings, the plurality of centroids comprising a first centroid; determining, with at least one processor, an attention operator for at least one node-centroid pairing, the at least one node-centroid pairing comprising the first node and the first centroid, the attention operator configured to measure a similarity between the first node and the first centroid; and generating, with at least one processor, relational data corresponding to a relation between the first node and at least one third node comprising a non-neighbor node of the first node using the attention operator.

Clause 2: The method of clause 1, further comprising: generating, with at least one processor, a recommendation based on the relational data.

Clause 3: The method of clauses 1 or 2, wherein the first node corresponds to a first user, wherein the historical data comprises a plurality of first user-item pairings corresponding to historical transactions of the first user, wherein the method further comprises: generating, with at least one processor, a first recommendation for the first user based on the relational data, the first recommendation comprising an item not directly associated with the first user in the historical data; and transmitting, with at least one processor, the first recommendation to a device of the first user.

Clause 4: The method of any of clauses 1-3, wherein a plurality of layers of the graph neural network are generated, wherein the clustering is performed in between each layer of the graph neural network generated, and each subsequent layer is generated using at least one centroid formed at a preceding layer.

Clause 5: The method of any of clauses 1-4, wherein the attention operator includes a multi-headed attention.

Clause 6: The method of any of clauses 1-5, further comprising: generating, with at least one processor, based on the attention operator and the aggregated node data from the first node and the at least one second node comprising the neighbor node of the first node, a mixed embedding, wherein the relational data is generated based on the mixed embedding.

Clause 7: A system for determining long-range dependencies using a non-local graph neural network, comprising at least one processor programmed and/or configured to: receive a dataset comprising historical data; generate at least one layer of a graph neural network by generating graph convolutions to compute node embeddings for a plurality of nodes of the dataset, the graph convolutions generated by aggregating node data from a first node of the dataset and node data from at least one second node comprising a neighbor node of the first node; cluster the node embeddings to form a plurality of centroids, each centroid corresponding to a graph-level representation of a plurality of node embeddings, the plurality of centroids comprising a first centroid; determine an attention operator for at least one node-centroid pairing, the at least one node-centroid pairing comprising the first node and the first centroid, the attention operator configured to measure a similarity between the first node and the first centroid; and generate relational data corresponding to a relation between the first node and at least one third node comprising a non-neighbor node of the first node using the attention operator.

Clause 8: The system of clause 7, wherein the at least one processor is programmed and/or configured to: generate a recommendation based on the relational data.

Clause 9: The system of clauses 7 or 8, wherein the first node corresponds to a first user, wherein the historical data comprises a plurality of first user-item pairings corresponding to historical transactions of the first user, wherein the at least one processor is programmed and/or configured to: generate a first recommendation for the first user based on the relational data, the first recommendation comprising an item not directly associated with the first user in the historical data; and transmit the first recommendation to a device of the first user.

Clause 10: The system of any of clauses 7-9, wherein a plurality of layers of the graph neural network are generated, wherein the clustering is performed in between each layer of the graph neural network generated, and each subsequent layer is generated using at least one centroid formed at a preceding layer.

Clause 11: The system of any of clauses 7-10, wherein the attention operator includes a multi-headed attention.

Clause 12: The system of any of clauses 7-11, wherein the at least one processor is programmed and/or configured to: generate, based on the attention operator and the aggregated node data from the first node and the at least one second node comprising the neighbor node of the first node, a mixed embedding, wherein the relational data is generated based on the mixed embedding.

Clause 13: A computer program product for determining long-range dependencies using a non-local graph neural network, comprising at least one non-transitory computer-readable medium including program instructions that, when executed by at least one processor, cause the at least one processor to: receive a dataset comprising historical data; generate at least one layer of a graph neural network by generating graph convolutions to compute node embeddings for a plurality of nodes of the dataset, the graph convolutions generated by aggregating node data from a first node of the dataset and node data from at least one second node comprising a neighbor node of the first node; cluster the node embeddings to form a plurality of centroids, each centroid corresponding to a graph-level representation of a plurality of node embeddings, the plurality of centroids comprising a first centroid; determine an attention operator for at least one node-centroid pairing, the at least one node-centroid pairing comprising the first node and the first centroid, the attention operator configured to measure a similarity between the first node and the first centroid; and generate relational data corresponding to a relation between the first node and at least one third node comprising a non-neighbor node of the first node using the attention operator.

Clause 14: The computer program product of clause 13, wherein the program instructions cause the at least one processor to: generate a recommendation based on the relational data.

Clause 15: The computer program product of clauses 13 or 14, wherein the first node corresponds to a first user, wherein the historical data comprises a plurality of first user-item pairings corresponding to historical transactions of the first user, wherein the program instructions cause the at least one processor to: generate a first recommendation for the first user based on the relational data, the first recommendation comprising an item not directly associated with the first user in the historical data; and transmit the first recommendation to a device of the first user.

Clause 16: The computer program product of any of clauses 13-15, wherein a plurality of layers of the graph neural network are generated, wherein the clustering is performed in between each layer of the graph neural network generated, and each subsequent layer is generated using at least one centroid formed at a preceding layer.

Clause 17: The computer program product of any of clauses 13-16, wherein the attention operator includes a multi-headed attention.

Clause 18: The computer program product of any of clauses 13-17, wherein the program instructions cause the at least one processor to: generate, based on the attention operator and the aggregated node data from the first node and the at least one second node comprising the neighbor node of the first node, a mixed embedding, wherein the relational data is generated based on the mixed embedding.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a schematic diagram of a system for determining long-range dependencies using a non-local graph neural network (GNN) according to non-limiting embodiments or aspects;

FIG. 2 is a diagram of a non-limiting embodiment or aspect of an environment in which methods, systems, and/or computer program products, described herein, may be implemented according to the principles of the presently disclosed subject matter;

FIG. 3 is a diagram of one or more components, devices, and/or systems according to non-limiting embodiments or aspects;

FIG. 4 is a flowchart of non-limiting embodiments or aspects of a process for determining long-range dependencies using a non-local GNN according to non-limiting embodiments or aspects;

FIG. 5 is a diagram showing where non-limiting embodiments or aspects of a target user/item node may aggregate each of local messages (e.g., neighbors) and non-local messages (e.g., user/item centroids);

FIG. 6 is a diagram including pseudocode for training non-limiting embodiments or aspects of a graph optimal transport network (GOTNet);

FIG. 7 is a table that briefly summarizes statistics of datasets on which experiments are conducted;

FIG. 8 is a table that summarizes performance comparisons of different models;

FIG. 9 is graphs of results of different GNNs with varying number of layers;

FIG. 10A is a table that shows performance of different models for sparse recommendation;

FIG. 10B is graphs of training curves of training loss and testing NDCG for different models;

FIG. 11A is graphs that show parameter sensitivity of a GOTNet according to non-limiting embodiments or aspects;

FIG. 11B is graphs that show impacts of clustering sizes and attention heads; and

FIG. 12 is an illustration of local and non-local operators for collecting long-range messages.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like, operated by or on behalf of a payment gateway.

The term “processor,” as used herein, may represent any type of processing unit, such as a single processor having one or more cores, one or more cores of one or more processors, multiple processors each having one or more cores, and/or other arrangements and combinations of processing units.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Graph Neural Networks (GNNs) are being widely used in recommender systems, owing to their theoretical elegance and good performance. By considering user-time interactions as bipartite graphs, GNNs learn the representation of a user/item through an iterative process of transferring, transforming, and aggregating the information from its neighbors, which allows obtaining expressive representations of users and items and achieving state-of-the-art performance. For example, PinSage combines random walks and graph convolutions to generate item embeddings. Neural Graph Collaborative Filtering (NGCF) exploits the multi-hop community information to harvest the high-order collaborative signals between users and items. LightGCN further simplifies the design of NGCF to make it more concise for recommendation.

Despite their encouraging performance, many GNNs use a fairly shallow architecture to obtain node embeddings, and thus have no ability to capture long-range dependencies in graphs. A reason is that graph convolutions are naturally local operators, for example, a single graph convolution only aggregates messages from a node's one-hop neighborhoods. Clearly, a k-layer GNN model can collect relational information up to k-hops away, but cannot discover the dependency with a range longer than k-hops away from any given node. Therefore, the ability of GNNs to capture long-range dependencies heavily depends on their depths.

While in principle deep GNNs should have more expressive ability to model complex graph structures, training deep GNNs poses unique challenges in practice. It is computationally inefficient because the complexity of GNNs is exponential to the number of layers, causing high demand on training time and GPU memory. It also makes optimization difficult. Deep GNNs suffer from issues of overfitting, oversmoothing, and possible vanishing gradient. These “bottleneck effects” may inhibit the potential benefits of deep GNNs. Further, repeating GNN operators implicitly assumes homophily in graphs. However, real-word graphs, for example, for implicit user-item graphs, are often complex and exhibit a mixture of topological homophily or heterophily. Therefore, training deep GNNs may cause unexpected results if GNNs are not well regularized.

In recent years, non-local neural networks have shed light on capturing long-range dependencies in computer vision domains. For example, non-local neural networks first measure the pairwise relations between query position and all positions to form an attention map, and then aggregate the features by using self-attention mechanism. This choice of design enables messages to be efficiently communicated across the whole images. For graph domains, Geometric Graph Convolutional Network (Geom-GCN) proposes geometric aggregators to compute the Euclidean distance between every pair of nodes. However, Geom-GCN is computationally prohibitive for large graphs as it requires to measure node-level pairwise relations, resulting in quadratic complexity. To remedy this issue, the recently proposed Non-Local Graph Convolution Network (NL-GCN) leverages attention-guided sorting with a single calibration vector to redefine non-local neighborhoods. Nevertheless, NL-GCN solely calibrates the output embeddings of GNNs, which lacks adaptability.

Non-limiting embodiments or aspects of the disclosed subject matter are directed to methods, systems, and computer program products for determining long-range dependencies using a GNN. For example, non-limiting embodiments or aspects of the disclosed subject matter determine long-range dependencies while running fewer depths (e.g., layers) of the GNN. By running fewer depths of the GNN, significant processing resources are saved, while still achieving an output that includes relational data between two parameters of the input dataset. Moreover, running fewer depths saves significant processing time, thus enabling the relational data to be determined faster. Still further, running fewer depths helps preserve the integrity of the generated data by avoiding over-fitting or over-smoothing, which can be present after too many depths of the GNN are run. While saving processing resources, time, and data integrity, the relational data generated according to the disclosed subject matter provides accurate long-range dependency of parameters of the dataset such that accurate and useful recommendations based thereon may be generated.

To achieve these benefits without running excessive depths of the GNN, non-limiting embodiments or aspects of the disclosed subject matter combine the graph convolutions of GNN with clustering. Graph convolutions may be generated to compute node embeddings for nodes of the dataset based on neighbor nodes, and these node embeddings may then be clustered to determine centroids. The centroids correspond to graph-level representations of a plurality of node embeddings, and may be used in downstream processing to determine long-range dependencies faster and while running fewer depths of the GNN. The centroids may be used to determine an attention operator for node-centroid pairs (as opposed to node-node pairs), and the attention operator may be configured to measure a similarity between a node-centroid pair. The attention operator may be used to determine relational data for non-neighbor nodes while running fewer depths of the GNN.

In this way, non-limiting embodiments or aspects of the present disclosure provide a highly-scalable Graph Optimal Transport Network (GOTNet) to capture long-range dependencies without increasing the depths of GNNs. For example, GOTNet may marry graph convolutions and clustering methods to achieve effective local and non-local encoding. As an example, at each layer, graph convolutions may be used to compute node embeddings by aggregating information from their local neighbors. In such an example, GOTNet may perform k-Means clustering in the users' and items' spaces to obtain their graph-level representations (e.g., user/item centroids), and/or a non-local attention operator may be used to measure the similarity between every pair of node-centroid, which enables long-range messages to be communicated among distant but similar nodes.

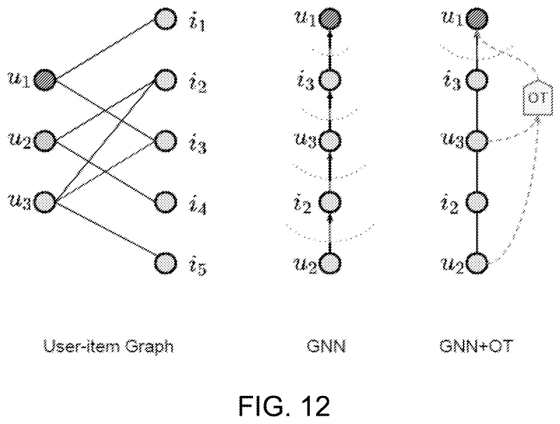

FIG. 12 illustrates how the long-range messages are propagated via local and non-local graph convolutional operators, respectively. Given target user u₁, the local operators in existing GNNs require two layers (e.g., u₁←i₃←u₃) to aggregate information from its 2-hops user u₃, and four layers (e.g., u₁←i₃←u₃←i₂←u₂) for its 4-hops user u₂. In contrast, non-local operators used by non-limiting embodiments or aspects of the present disclosure may perform fast clustering on all users via Optimal Transport (OT) and compute the attention once per cluster. As such, one single layer is sufficient to collect cluster-level messages from all users (e.g., u₁ [symbol] u₃ and u₁ [symbol] u₂). These non-local attention operators can seamlessly work with local operators in original GNNs. Accordingly, a GOTNet according to non-limiting embodiments or aspects is able to capture both local and non-local message passing in graphs by only using shallow GNNs, which avoids the bottleneck effects of deep GNNs.

The introduced k-Means clustering in GNNs has a variety of merits: 1) By clustering items (users) into groups, the similarities of the users or items do not change significantly inside a group, which enables users to do item-centric exploration of inventories; 2) Unlike measuring pairwise attentions for every query in Geom-GCN, user/item queries may be grouped into clusters and node-centroid attentions may be computed, which yields linear complexity as the number of centroids in graphs is often very small; and 3) As clustering is performed on each layer of GNNs, and the major network architecture stays unchanged, a GOTNet according to non-limiting embodiments or aspects is model-agnostic and can be applied to any GNN. In addition, k-Means clustering contains non-differentiable operators, which are not suitable for end-to-end training. By revisiting the k-Means clustering as an OT task, a fully differential clustering is derived that can be jointly trained with GNNs at scale.

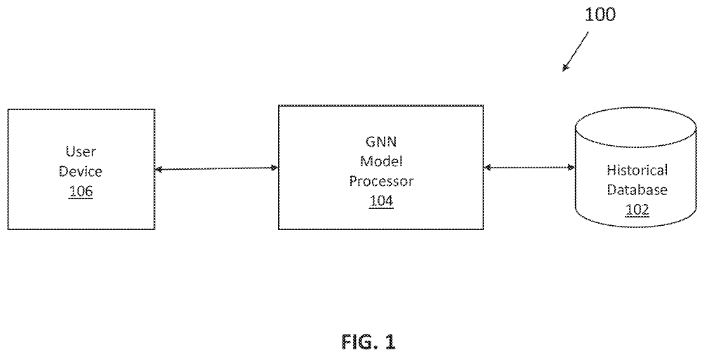

Referring to FIG. 1, a system 100 is shown for determining long-range dependencies using a non-local graph neural network according to non-limiting embodiments or aspects. The system 100 may include a historical database 102 containing at least one dataset. The dataset may include a plurality of data entries, and the dataset may contain data associated with any subject matter. In some non-limiting embodiments or aspects, the historical database 102 may contain data associated with transactions engaged in by users for items, such as electronic payment transactions between users and merchants. The data may identify items purchased, rented, viewed, experienced, and/or queried by the user (e.g., user-item pairings). The items may include goods and/or services. A GNN model processor 104 may generate recommendations for the user based on the dataset from the historical database 102, which recommendations may include recommendations of items for which the user may have an interest.

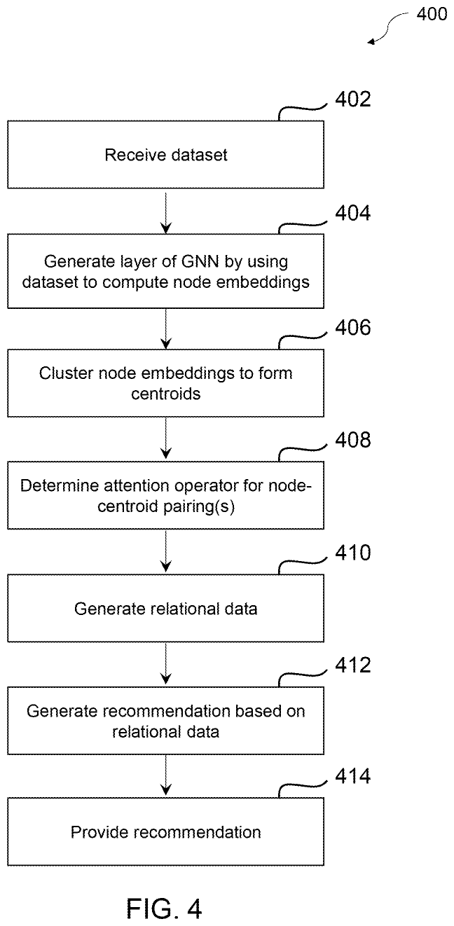

While generating user-item recommendations has been specifically described, it will be appreciated that the system 100 may be applied to datasets of any subject matter to generate recommendations relevant to the datasets. Additional non-limiting examples of datasets and/or applications for generating recommendations are provided herein with regard to FIGS. 4-12.

With continued reference to FIG. 1, the GNN model processor 104 may determine long-range dependencies by executing a GNN. The long-range dependencies may comprise relational data quantifying a relation between two parameters in a dataset. The relational data may comprise a rating which corresponds to the likelihood of a relation between the two parameters. For example, in the user-item scenario, the rating may indicate the likelihood that the user may be interested in purchasing, renting, viewing, experiencing, and/or querying the corresponding item. The rating may be in any form, such as a numerical rating. A long-range dependency refers to the relational data between two parameters corresponding to non-neighbor (hence “long-range”) nodes in a GNN of the dataset. In the user-item scenario, this may refer to an item not previously purchased, rented, viewed, experienced, and/or queried by the user

The GNN model processor 104 may determine the long-range dependencies using the techniques described as provided herein with regard to FIGS. 4-12. The GNN model processor 104 may receive a dataset comprising historical data from the historical database 102. The GNN model processor 104 may generate at least one layer of a GNN by generating graph convolutions to compute node embeddings for a plurality of nodes of the dataset. The graph convolutions may be generated by aggregating node data from a first node of the dataset and node data from at least one second node comprising a neighbor node of the first node. The GNN model processor 104 may cluster the node embeddings to form a plurality of centroids, each centroid corresponding to a graph-level representation of a plurality of node embeddings, the plurality of centroids comprising a first centroid. The GNN model processor 104 may determine an attention operator for at least one node-centroid pairing, the at least one node-centroid pairing comprising the first node and the first centroid, the attention operator configured to measure a similarity between the first node and the first centroid. The GNN model processor 104 may generate relational data corresponding to a relation between the first node and at least one third node comprising a non-neighbor node of the first node using the attention operator.

The GNN model processor 104 may generate a recommendation based on the relational data.

The GNN model processor 104 may generate a plurality of layers of the GNN, where the clustering is performed in between each layer of the GNN generated, and each subsequent layer is generated using at least one centroid formed at a preceding layer.

With continued reference to FIG. 1, the GNN model processor 104 may transmit a recommendation for the user to the user device 106. The user device 106 may be a computing device.

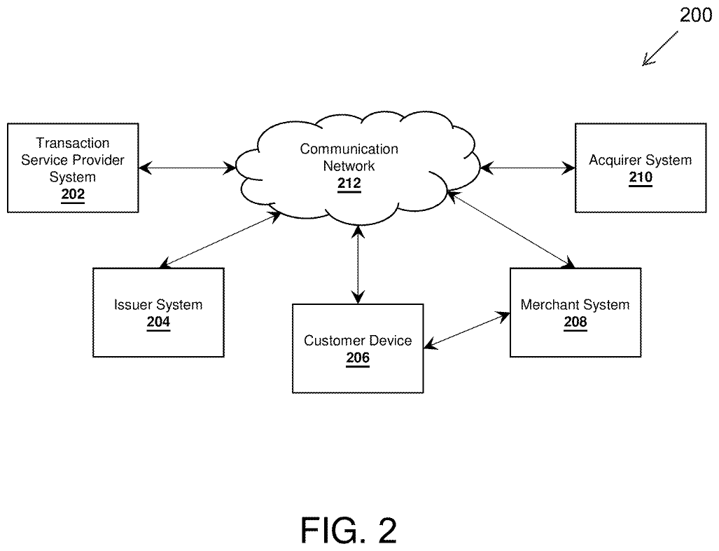

Referring to FIG. 2, FIG. 2 is a diagram of a non-limiting embodiment or aspect of an exemplary environment 200 in which systems, products, and/or methods, as described herein, may be implemented. As shown in FIG. 2, environment 200 may include transaction service provider system 202, issuer system 204, customer device 206, merchant system 208, acquirer system 210, and communication network 212. In some non-limiting embodiments or aspects, each of the GNN model processor 104 and the historical database 102 may be implemented by (e.g., part of) transaction service provider system 202, issuer system 204, merchant system 208, and/or acquirer system 210. In some non-limiting embodiments or aspects, at least one of the GNN model processor 104 and the historical database 102 may be implemented by (e.g., part of) another system, another device, another group of systems, or another group of devices, separate from or including transaction service provider system 202, issuer system 204, merchant system 208, acquirer system 210, and/or the like.

Transaction service provider system 202 may include one or more devices capable of receiving information from and/or communicating information to issuer system 204, customer device 206, merchant system 208, and/or acquirer system 210 via communication network 212. For example, transaction service provider system 202 may include a computing device, such as a server (e.g., a transaction processing server), a group of servers, and/or other like devices. In some non-limiting embodiments or aspects, transaction service provider system 202 may be associated with a transaction service provider as described herein. In some non-limiting embodiments or aspects, transaction service provider system 202 may be in communication with a data storage device, which may be local or remote to transaction service provider system 202. In some non-limiting embodiments or aspects, transaction service provider system 202 may be capable of receiving information from, storing information in, communicating information to, or searching information stored in the data storage device. The data storage device may be the same or different from the historical database 102.

Issuer system 204 may include one or more devices capable of receiving information and/or communicating information to transaction service provider system 202, customer device 206, merchant system 208, and/or acquirer system 210 via communication network 212. For example, issuer system 204 may include a computing device, such as a server, a group of servers, and/or other like devices. In some non-limiting embodiments or aspects, issuer system 204 may be associated with an issuer institution as described herein. For example, issuer system 204 may be associated with an issuer institution that issued a credit account, debit account, credit card, debit card, and/or the like to a user associated with customer device 206.

Customer device 206 may include one or more computing devices capable of receiving information from and/or communicating information to transaction service provider system 202, issuer system 204, merchant system 208, and/or acquirer system 210 via communication network 212. Additionally or alternatively, each customer device 206 may include a device capable of receiving information from and/or communicating information to other customer devices 206 via communication network 212, another network (e.g., an ad hoc network, a local network, a private network, a virtual private network, and/or the like), and/or any other suitable communication technique. For example, customer device 206 may include a client device and/or the like. In some non-limiting embodiments or aspects, customer device 206 may or may not be capable of receiving information (e.g., from merchant system 208 or from another customer device 206) via a short-range wireless communication connection (e.g., an NFC communication connection, an RFID communication connection, a Bluetooth® communication connection, a Zigbee® communication connection, and/or the like), and/or communicating information (e.g., to merchant system 208) via a short-range wireless communication connection.

Merchant system 208 may include one or more devices capable of receiving information from and/or communicating information to transaction service provider system 202, issuer system 204, customer device 206, and/or acquirer system 210 via communication network 212. Merchant system 208 may also include a device capable of receiving information from customer device 206 via communication network 212, a communication connection (e.g., an NFC communication connection, an RFID communication connection, a Bluetooth® communication connection, a Zigbee® communication connection, and/or the like) with customer device 206, and/or the like, and/or communicating information to customer device 206 via communication network 212, the communication connection, and/or the like. In some non-limiting embodiments or aspects, merchant system 208 may include a computing device, such as a server, a group of servers, a client device, a group of client devices, and/or other like devices. In some non-limiting embodiments or aspects, merchant system 208 may be associated with a merchant as described herein. In some non-limiting embodiments or aspects, merchant system 208 may include one or more client devices. For example, merchant system 208 may include a client device that allows a merchant to communicate information to transaction service provider system 202. In some non-limiting embodiments or aspects, merchant system 208 may include one or more devices, such as computers, computer systems, and/or peripheral devices capable of being used by a merchant to conduct a transaction with a user. For example, merchant system 208 may include a POS device and/or a POS system.

Acquirer system 210 may include one or more devices capable of receiving information from and/or communicating information to transaction service provider system 202, issuer system 204, customer device 206, and/or merchant system 208 via communication network 212. For example, acquirer system 210 may include a computing device, a server, a group of servers, and/or the like. In some non-limiting embodiments or aspects, acquirer system 210 may be associated with an acquirer as described herein.

Communication network 212 may include one or more wired and/or wireless networks. For example, communication network 212 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, processing a transaction may include generating and/or communicating at least one transaction message (e.g., authorization request, authorization response, any combination thereof, and/or the like). For example, a client device (e.g., customer device 206, a POS device of merchant system 208, and/or the like) may initiate the transaction, e.g., by generating an authorization request. Additionally or alternatively, the client device (e.g., customer device 206, at least one device of merchant system 208, and/or the like) may communicate the authorization request. For example, customer device 206 may communicate the authorization request to merchant system 208 and/or a payment gateway (e.g., a payment gateway of transaction service provider system 202, a third-party payment gateway separate from transaction service provider system 202, and/or the like). Additionally or alternatively, merchant system 208 (e.g., a POS device thereof) may communicate the authorization request to acquirer system 210 and/or a payment gateway. In some non-limiting embodiments or aspects, acquirer system 210 and/or a payment gateway may communicate the authorization request to transaction service provider system 202 and/or issuer system 204. Additionally or alternatively, transaction service provider system 202 may communicate the authorization request to issuer system 204. In some non-limiting embodiments or aspects, issuer system 204 may determine an authorization decision (e.g., authorize, decline, and/or the like) based on the authorization request. For example, the authorization request may cause issuer system 204 to determine the authorization decision based thereon. In some non-limiting embodiments or aspects, issuer system 204 may generate an authorization response based on the authorization decision. Additionally or alternatively, issuer system 204 may communicate the authorization response. For example, issuer system 204 may communicate the authorization response to transaction service provider system 202 and/or a payment gateway. Additionally or alternatively, transaction service provider system 202 and/or a payment gateway may communicate the authorization response to acquirer system 210, merchant system 208, and/or customer device 206. Additionally or alternatively, acquirer system 210 may communicate the authorization response to merchant system 208 and/or a payment gateway. Additionally or alternatively, a payment gateway may communicate the authorization response to merchant system 208 and/or customer device 206. Additionally or alternatively, merchant system 208 may communicate the authorization response to customer device 206. In some non-limiting embodiments or aspects, merchant system 208 may receive (e.g., from acquirer system 210 and/or a payment gateway) the authorization response. Additionally or alternatively, merchant system 208 may complete the transaction based on the authorization response (e.g., provide, ship, and/or deliver goods and/or services associated with the transaction; fulfill an order associated with the transaction; any combination thereof; and/or the like).

For the purpose of illustration, processing a transaction may include generating a transaction message (e.g., authorization request and/or the like) based on an account identifier of a customer (e.g., associated with customer device 206 and/or the like) and/or transaction data associated with the transaction. For example, merchant system 208 (e.g., a client device of merchant system 208, a POS device of merchant system 208, and/or the like) may initiate the transaction, e.g., by generating an authorization request (e.g., in response to receiving the account identifier from a payment device of the customer and/or the like). Additionally or alternatively, merchant system 208 may communicate the authorization request to acquirer system 210. Additionally or alternatively, acquirer system 210 may communicate the authorization request to transaction service provider system 202. Additionally or alternatively, transaction service provider system 202 may communicate the authorization request to issuer system 204. Issuer system 204 may determine an authorization decision (e.g., authorize, decline, and/or the like) based on the authorization request, and/or issuer system 204 may generate an authorization response based on the authorization decision and/or the authorization request. Additionally or alternatively, issuer system 204 may communicate the authorization response to transaction service provider system 202. Additionally or alternatively, transaction service provider system 202 may communicate the authorization response to acquirer system 210, which may communicate the authorization response to merchant system 208.

For the purpose of illustration, clearing and/or settlement of a transaction may include generating a message (e.g., clearing message, settlement message, and/or the like) based on an account identifier of a customer (e.g., associated with customer device 206 and/or the like) and/or transaction data associated with the transaction. For example, merchant system 208 may generate at least one clearing message (e.g., a plurality of clearing messages, a batch of clearing messages, and/or the like). Additionally or alternatively, merchant system 208 may communicate the clearing message(s) to acquirer system 210. Additionally or alternatively, acquirer system 210 may communicate the clearing message(s) to transaction service provider system 202. Additionally or alternatively, transaction service provider system 202 may communicate the clearing message(s) to issuer system 204. Additionally or alternatively, issuer system 204 may generate at least one settlement message based on the clearing message(s). Additionally or alternatively, issuer system 204 may communicate the settlement message(s) and/or funds to transaction service provider system 202 (and/or a settlement bank system associated with transaction service provider system 202). Additionally or alternatively, transaction service provider system 202 (and/or the settlement bank system) may communicate the settlement message(s) and/or funds to acquirer system 210, which may communicate the settlement message(s) and/or funds to merchant system 208 (and/or an account associated with merchant system 208).

The number and arrangement of systems, devices, and/or networks shown in FIG. 2 are provided as an example. There may be additional systems, devices, and/or networks; fewer systems, devices, and/or networks; different systems, devices, and/or networks; and/or differently arranged systems, devices, and/or networks than those shown in FIG. 2. Furthermore, two or more systems or devices shown in FIG. 2 may be implemented within a single system or device, or a single system or device shown in FIG. 2 may be implemented as multiple, distributed systems or devices. Additionally or alternatively, a set of systems (e.g., one or more systems) or a set of devices (e.g., one or more devices) of environment 200 may perform one or more functions described as being performed by another set of systems or another set of devices of environment 200.

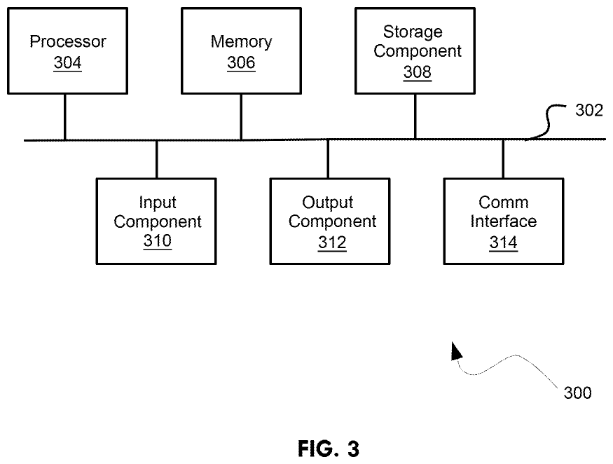

Referring to FIG. 3, shown is a diagram of example components of a device 300 according to non-limiting embodiments. Device 300 may correspond to the user device 106, GNN model processor 104, historical database 102, transaction service provider system 202, issuer system 204, customer device 206, merchant system 208, and acquirer system 210 shown in FIGS. 1 and 2. In some non-limiting embodiments, such systems or devices may include at least one device 300 and/or at least one component of device 300. The number and arrangement of components shown in FIG. 3 are provided as an example. In some non-limiting embodiments, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

As shown in FIG. 3, device 300 may include a bus 302, a processor 304, memory 306, a storage component 308, an input component 310, an output component 312, and a communication interface 314. Bus 302 may include a component that permits communication among the components of device 300. In some non-limiting embodiments, processor 304 may be implemented in hardware, firmware, or a combination of hardware and software. For example, processor 304 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 may include random access memory (RAM), read only memory (ROM), and/or another type of dynamic or static storage device (e.g., flash memory, magnetic memory, optical memory, etc.) that stores information and/or instructions for use by processor 304.

With continued reference to FIG. 3, storage component 308 may store information and/or software related to the operation and use of device 300. For example, storage component 308 may include a hard disk (e.g., a magnetic disk, an optical disk, a magneto-optic disk, a solid state disk, etc.) and/or another type of computer-readable medium. Input component 310 may include a component that permits device 300 to receive information, such as via user input (e.g., a touch screen display, a keyboard, a keypad, a mouse, a button, a switch, a microphone, etc.). Additionally, or alternatively, input component 310 may include a sensor for sensing information (e.g., a global positioning system (GPS) component, an accelerometer, a gyroscope, an actuator, etc.). Output component 312 may include a component that provides output information from device 300 (e.g., a display, a speaker, one or more light-emitting diodes (LEDs), etc.). Communication interface 314 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 300 may perform one or more processes described herein. Device 300 may perform these processes based on processor 304 executing software instructions stored by a computer-readable medium, such as memory 306 and/or storage component 308. A computer-readable medium may include any non-transitory memory device. A memory device includes memory space located inside of a single physical storage device or memory space spread across multiple physical storage devices. Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices. The terms “programmed to” and/or “configured to,” as used herein, may refer to an arrangement of software, device(s), and/or hardware for performing and/or enabling one or more functions (e.g., actions, processes, steps of a process, and/or the like). For example, “a processor programmed and/or configured to” may refer to a processor that executes software instructions (e.g., program code) that cause the processor to perform one or more functions.

Referring now to FIG. 4, FIG. 4 is a flowchart of non-limiting embodiments or aspects of a process 400 for determining long-range dependencies using a non-local GNN. In some non-limiting embodiments or aspects, one or more of the steps of process 400 may be performed (e.g., completely, partially, etc.) by GNN model processor 104 (e.g., one or more devices of GNN model processor 104). In some non-limiting embodiments or aspects, one or more of the steps of process 400 may be performed (e.g., completely, partially, etc.) by another device or a group of devices separate from or including GNN model processor 104, such as, historical database 102 (e.g., one or more devices of historical database 102, etc.) and/or user device 106 (e.g., one or more devices of a system of user device 106, etc.).

As shown in FIG. 4, at step 402, process 400 includes receiving a dataset. For example, GNN model processor 104 may receive a dataset comprising historical data. As an example, the dataset may include a plurality of data entries, and the dataset may contain data associated with any subject matter. In some non-limiting embodiments or aspects, historical database 102 may contain historical data associated with transactions engaged in by users for items, such as electronic payment transactions between users and merchants. The data may identify items purchased, rented, viewed, experienced, and/or queried by the user (e.g., user-item pairings). The items may include goods and/or services.

For example, a dataset may include behavior data (e.g., click, comment, purchase, etc.) that includes a set of users U={u} and items I={i}, such that the set Iᵤ ⁺ represents the items that user u has interacted with before, while Iᵤ⁻=I−Iᵤ⁺ represents unobserved items. In such an example, a goal of GNN model processor 104 may be to estimate user preference towards unobserved items.

By viewing user-item interactions of a dataset as a bipartite graph G, a user-item interaction matrix or graph A∈ [symbol] ^{N×M} can be constructed, where N and M denote the number of users and items, respectively. For example, each entry Aᵤᵢ=1 if user u has interacted with item i, and Aᵤᵢ=0 otherwise. As an example, GNN model processor 104 may recommend a ranked list of items from Iᵤ⁻ that are of interests to the user u∈U, in the same sense that inferring the unobserved links in the bipartite graph G.

As shown in FIG. 4, at step 404, process 400 includes generating at least one layer of a graph neural network by using a dataset to compute node embeddings. For example, GNN model processor 104 may generate at least one layer of a graph neural network by generating graph convolutions to compute node embeddings for a plurality of nodes of the dataset, the graph convolutions generated by aggregating node data from a first node of the dataset and node data from at least one second node comprising a neighbor node of the first node. As an example, a plurality of layers of the graph neural network may be generated. In such an example, the clustering described herein with respect to step 406 may be performed in between each layer of the graph neural network formed, and each subsequent layer may be generated using at least one centroid generated at a preceding layer.

GNNs provide promising results for recommendations, such as Pin-Sage, NGCF, and LightGCN. An aspect of GNNs is to learn node embeddings by smoothing features over graphs. The design of LightGCN, including embedding lookup, aggregation, pooling, and optimization, is provided as an example.

Initial representations of a user u and an item i can be obtained via embedding lookup tables according to the following Equation (1):

$$\begin{matrix}{e}_{u}^{( 0 )} = lookup ( u ) , & {e}_{i}^{( 0 )} = lookup ( i ) ,\end{matrix} \qquad ( 1 )$$

where u and i denote the IDs of user and item, eᵤ⁽⁰⁾∈R^{d} and eᵢ⁽⁰⁾ ∈R^{d} are the embedding of user u and item i, respectively, and d is the embedding size. These embeddings can be directly fed into a GNN model.

GNNs may perform graph convolution iteratively, for example, aggregating features of neighbors to refine the embedding of a target node. Taking LightGCN as an example, its aggregator is defined according to the following Equation (2):

$${e}_{u}^{( l )} = {\sum }_{i ∈ {𝒩}_{u}} \frac{1}{\sqrt{\vert {𝒩}_{u} \vert \vert {𝒩}_{i} \vert}} {e}_{i}^{( l - 1 )} , {e}_{i}^{( l )} = {\sum }_{u ∈ {𝒩}_{i}} \frac{1}{\sqrt{\vert {𝒩}_{i} \vert \vert {𝒩}_{u} \vert}} {e}_{u}^{( l - 1 )} , \qquad ( 2 )$$

where eᵤ^{(l)} and eᵢ^{(l)}, with initialization eᵤ⁽⁰⁾ and eᵢ⁽⁰⁾ in Equation (1), denote the refined embeddings of user u and item i after i-layer propagation, respectively, Nᵤ denotes the set of items that are directly interactive by user u, and Nᵢ is defined in a same way. Each of Nᵤ and Nᵢ can be retrieved from the user-item graph A.

GNNs may adopt pooling techniques to readout the final representations of users/items. For example, after propagating L layer, LightGCN obtains L+1 embeddings to represent a user eᵤ⁽⁰⁾, . . . , eᵤ^{(L)} and an item eᵢ⁽⁰⁾, . . . , eᵢ^{(L)}. A weighted sum-based pooling may be used to obtain the final representations according to the following Equation (3):

$$\begin{matrix}{e}_{u}^{*} = {\sum }_{l = 0}^{L} {ρ}_{l} {e}_{u}^{( l )} , & {e}_{i}^{*} = {\sum }_{l = 0}^{L} {ρ}_{l} {e}_{i}^{( l )} ,\end{matrix} \qquad ( 3 )$$

where ρₗ denotes the importance of the l-th layer embedding in constructing the final embeddings, which can be tuned manually.

Inner product may be conducted to estimate the user's preference towards the target item according to the following Equation (4):

$${\hat{y}}_{ui} = {e}_{u}^{* T} {e}_{i}^{*} \qquad ( 4 )$$

The Bayesian Personalized Ranking (BPR) loss can be adopted to optimize the model parameters. An idea behind pairwise BPR loss is that an observed item should be predicted with a higher score than an unobserved one, which can be achieved by minimizing loss according to the following Equation (5):

$${ℒ}_{BPR} ( Θ ) = {\sum }_{( u , i , j ) ∈ O} - ln σ ( {\hat{y}}_{ui} - {\hat{y}}_{uj} ) + α {‖ Θ ‖}_{2}^{2} , \qquad ( 5 )$$

where [symbol] ={(u, i, j)|u∈ [symbol] Λi∈Iᵤ⁺Λj∈Iᵤ⁻} denotes the pairwise training data, σ(·) is the sigmoid function, θ denotes model parameters, and a controls the L₂ norm of θ to inhibit or prevent overfitting.

The aggregator in Equation (2) plays a role in collecting messages from neighbors. However, the graph convolutions are essentially local operators (e.g., eᵤ only collects information from its first-order neighbors Nᵤ in each iteration). The ability of Light-GCN to capture long-range dependencies depends on its depth: at least k GNN layers are needed to capture information that is k-hops away from a target node. Indeed, training deeper GNNs increases the receptive fields, but causes several bottleneck effects, such as overfitting and oversmoothing. In fact, many of GNN-based recommendation models achieve their best performance with at most 3 or 4 layers.

Several regularization and normalization techniques have been suggested to overcome the bottleneck of deep GNNs, such as PairNorm, DropEdge, and skip connection. However, the performance gains of deeper architectures are not always significant nor consistent in many tasks. Also, the complexity of GNNs is exponential to the number of layers, causing high demand on training time and GPU memory. This barrier makes pursuit of deeper GNNs unpersuasive for billion-scale graphs.

As shown in FIG. 4, at step 406, process 400 includes clustering node embeddings to form centroids. For example, GNN model processor 104 may cluster the node embeddings to form a plurality of centroids, each centroid corresponding to a graph-level representation of a plurality of node embeddings, the plurality of centroids comprising a first centroid. As an example, GNN model processor 104 may obtain cluster-aware representations of users and items via a fully differential k-Means clustering.

Motivated by the fact that users with similar interests may purchase similar items, GNN model processor 104 may cluster the user/item embeddings into different groups for each layer of GNNs, which enables a node at any position to perceive contextual messages from all nodes, and which can benefit the GNNs to learn long-range dependencies. Clustering users/items are widely used in traditional collaborative filtering models, but far less studied in graph neural models.

For example, by letting {eᵤ₁, eᵤ₂, . . . , e_{uN}}⊂R^{d} denote all N user embedding in l-th layer of GNNs from Equation (2), GNN model processor 104 may perform k-Means clustering on the user embeddings. In general, these user embeddings from GNNs already live in low-dimensional space that is friendly to k-Means clustering. To make the model more flexible, GNN model processor 104 may further project the user space {ƒ_{θ}(eᵤ₁), ƒ_{θ}(eᵤ₂), . . . , ƒ_{θ}(e_{uN})}⊂ [symbol] ^{d} via a function ƒ_{θ}(·): R^{d}→R^{d}, where ƒ_{θ}(·) can be a neural network or a linear projection. For example, GNN model processor 104 may implement ƒ_{θ}(eᵤᵢ)=W·eᵤᵢ, for 1≤i≤N, where W∈ [symbol] ^{d×d} is a trainable weight. GNN model processor 104 may perform k-Means clustering in that low-dimensional space to obtain K user centroids {c₁, c₂, . . . , c_{K}}⊂ [symbol] ^{d} by minimizing according to the following Equation (6):

$${min}_{π ∈ \{ 0 , 1 \}} {\sum }_{i = 1}^{N} {\sum }_{k = 1}^{K} {π}_{ki} \cdot {‖ {f}_{θ} ( {e}_{{u}_{i}} ) - {c}_{k} ‖}_{2}^{2} , \qquad ( 6 )$$

where πₖᵢ indicates the cluster membership of user representation ƒ_{θ}(eᵤᵢ) w. r. t. centroid cₖ, for example, πₖᵢ=1 if data point ƒ_{θ}(eᵤᵢ) is assigned to cluster cₖ, and zero otherwise.

A goal of combining clustering and neural networks may be to obtain “k-Means friendly” space in which high-dimensional data has pseudo-labels, alleviating data annotation bottlenecks. However, non-limiting embodiments or aspects of the present disclosure may use k-Means to summarize the graph level information of users within clusters {c₁, c₂, . . . , c_{K}}, which can be used to deliver long-range messages via non-location attentions as described herein.

Solving Equation (6) may not be trivial because the term ƒ_{θ}(eᵤᵢ) involves another optimization task. EM-style methods may not be jointly optimized with the GNNs or ƒ_{θ} using standard gradient-based end-to-end learning, due to the non-differentiability of discrete cluster assignment in k-Means. Recent works attempt to address this issue by proposing surrogate losses and alternately optimizing neural networks and cluster assignments. However, it is not guaranteed that final representations are good for the clustering task if it has been optimized for another task. Non-limiting embodiments or aspects of the present disclosure may instead rewrite the k-Means as an Optimal Transport task, and derive a fully differentiable loss function for joint training.

Optimal Transport (OT) theory is introduced to study the problem of resource allocation with lowest transport cost. OT is a mathematical model that defines distances or similarities between objects such as probability distributions, either continuous or discrete, as the cost of an optimal transport plan from one to the other. By regarding the “cost” as distance, Wasserstein Distance is a commonly used metric for matching two distributions in OT.

Letting μ∈P( [symbol] ), v∈P( [symbol] ) denote two discrete distributions, where μ=Σᵢ₌₁ⁿ uᵢ δₓ_{ᵢ} and Σⱼ₌₁^{m} vⱼ δ_{y}_{ⱼ}, with δₓ as the Dirac function centered on x, Π(u, v) denotes all joint distributions γ(x,y), with marginals μ(x) and v(y). The weight vectors u={uᵢ}ᵢ₌₁ⁿ∈Δₙ and v={vᵢ}ᵢ₌₁^{m}∈Δₘ are the probability simplexes of size n and m, respectively, the probability simplex denoted by Δ_{K}={z∈ [symbol] ₊^{K}:Σₖ₌₁^{K}zₖ=1}. The Wasserstein distance between μ and v may then be defined according to the following Equation (7):

$$\begin{matrix}{𝒟}_{w} ( μ , v ) = {inf}_{γ ∈ \prod ( μ , v )} {𝔼}_{( x , y ) ∼ γ} [ c ( x , y ) ] \\ = {min}_{T ∈ \prod ( u , v )} {\sum }_{i = 1}^{n} {\sum }_{k = 1}^{m} {T}_{ij} \cdot c ( {x}_{i} , {y}_{j} ) ,\end{matrix} \qquad ( 7 )$$

where Π(u, v)={T∈ [symbol] ₊^{n×m}|T1ₘ=u, T^{T} 1ₙ=v}, 1ₙ denotes the n-dimensional vector of ones, and c(xᵢ,yⱼ) is the cost that evaluates the distance between xᵢ and yⱼ (e.g., samples of two distributions). The matrix T is denoted as the transport plan, where Tᵢⱼ represents the amount of mass shifted from uᵢ to vⱼ. The optimal solution T* is referred to as optimal transport plan.

Roughly speaking, OT is equivalent to constrained k-Means clustering. In order to parameterize k-Means using the optimal transport plan in Equation (7), GNN model processor 104 may employ a novel k-Means objective for clustering users according to the following Equation (8):

$$\begin{matrix}{min}_{π} {\sum }_{i = 1}^{N} {\sum }_{k = 1}^{K} {π}_{ki} \cdot {‖ {f}_{θ} ( {e}_{{u}_{i}} ) - {c}_{k} ‖}_{2}^{2} , & s . t . {π}^{T} {1}_{K} = \frac{1}{N} {1}_{N} , π {1}_{N} = \frac{1}{N} w ,\end{matrix} \qquad ( 8 )$$

where w=[n₁, . . . , n_{K}] denotes cluster proportions (e.g., nₖ is the number of points in the partition k, and Σₖ₌₁^{K} nₖ=N. The constraint π^{T}1_{K}=1_{N} implies the soft assignment πₖᵢ of each data point i to each cluster k, while π1_{N}=w further encourages that each cluster k contains exactly nₖ data points, In such an example, n₁= . . . =n_{K}=N/K may be set for balanced partitions, and/or the normalization factor 1/N may be introduced on both constraints, which follows the condition of probability simplex in OT and does not affect the loss. By doing so, the Equation (8) becomes a standard OT problem, and the cluster assignment T can be regarded as transport plan and the Euclidean distance ∥ƒ_{θ}(eᵤ_{ᵢ})−cₖ∥₂² as transport cost. If the second constraint on the size of each cluster is removed, Equation (8) becomes the original objective in Equation (6).

Equation (8) can be solved by Linear Programming (LP), yet with computational burden. This cost can be largely mitigated by introducing a strictly convex entropy regularized OT via fast Sinkhorn's algorithms. For example, GNN model processor 104 may use Sinkhorn loss of Equation (8) for clustering user loss [symbol] _{uoT} according to Equation (9):

$${ℒ}_{uOT} = {min}_{π} {\sum }_{i = 1}^{N} {\sum }_{k = 1}^{K} ( {π}_{ki} \cdot {‖ {f}_{θ} ( {e}_{{u}_{i}} ) - {c}_{k} ‖}_{2}^{2} + ε \cdot {π}_{ki} ( log {π}_{ki} - 1 ) ) \qquad ( 9 )$$

$$s . t . {π}^{T} {1}_{K} = \frac{1}{N} {1}_{N} , π {1}_{N} = \frac{1}{N} w ,$$

where ε>0 is a regularization parameter. LP algorithm reaches its optimums on vertices, while the entropy term moves the optimums away from the vertices, yielding smoother feasible regions. Sinkhorn operations are differentiable. Therefore, the use of Sinkhorn loss makes k-Means fully differentiable, which enables joint training with GNNs and ƒ_{θ} in a stochastic fashion. Analogously, the item clustering loss [symbol] ^{iOT} can be defined in a similar way.

To obtain cluster assignment π, GNN model processor 104 may use a greedy Sinkhorn algorithm (e.g., Greenkhorn as described by Jason Altschuler, Jonathan Weed, and Philippe Rigollet in the 2017 paper titled “Near-linear time approximation algorithms for optimal transport via Sinkhorn iteration” in NeurIPS at 1961-1971, the entire contents of which are incorporated herein by reference, etc.) to solve Equation (9), which accelerates training process significantly. As the optimal transport plan π* is computed, the centroids are refined:

$${c}_{k} = \frac{{\sum }_{i = 1}^{N} {π}_{k i}^{*} {f}_{θ} ( {e}_{u i} )}{{\sum }_{i = 1}^{N} {π}_{k i}^{*}} ,$$

for k=1, . . . , K. However, non-limiting embodiments or aspects of the present disclosure are not limited thereto, and other advanced solvers that may further improve numerical stability of training, such as Inexact Proximal point method for exact Optimal Transport problem (IPOT) and/or Scalable Push-forward of Optimal Transport (SPOT) may be used.

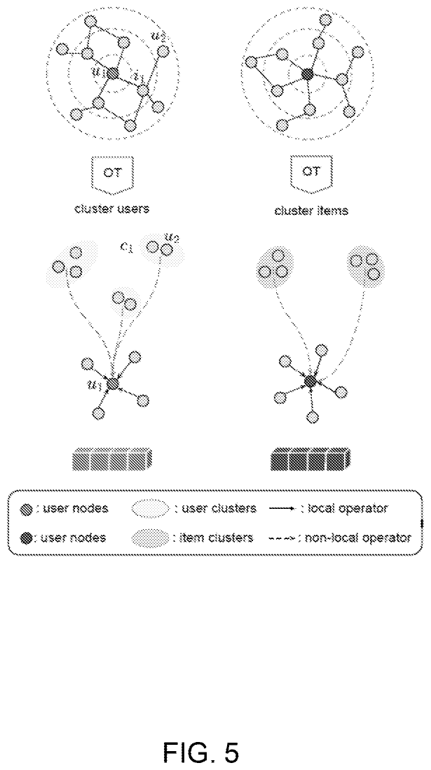

As shown in FIG. 4, at step 408, process 400 includes determining an attention operator for at least one node-centroid pairing. For example, GNN model processor 104 may determine an attention operator for at least one node-centroid pairing, the at least one node-centroid pairing comprising the first node and the first centroid, the attention operator configured to measure a similarity between the first node and the first centroid. As an example, GNN model processor 104 may capture long-range dependencies via pairwise node-centroid attentions (e.g., rather than node-node attentions). For example, and referring also to FIG. 5, which is a diagram showing where a target user/item node may aggregate each of local messages (e.g., neighbors) and non-local messages (e.g., user/item centroids), even though user u₁ and u₂ are 2-hops away from each other, the information of u₂ may be compactly represented by the centroid c₁, which can be passed to u₁ with one layer of GNN.

In GNNs, node embeddings are evolved due to iterative message passing. For each layer, a set of clusters C^{(l)}={c₁^{(l)}, c₂^{(l)}, . . . , c_{K}^{(l)}}⊂ [symbol] ^{d}, for 0≤l≤L can be obtained, via differential k-Means clustering. Similarly, a set of item clusters DY)={d₁^{(l)}, d₂^{(l)}, . . . , d_{K}^{(l)}}⊂ [symbol] ^{d}, for 0≤l≤L, can be computed by clustering item embeddings, where K and P denote the number of user and item clusters, respectively. The values of K and P may be invariant within GNNs.

Non-limiting embodiments or aspects of the present disclosure may collect relevant long-range messages via non-local node-centroid attentions. An attention module takes three groups of vectors as inputs, named the query vector, key vector, and value vector. Note that key and value vectors can be the same sometimes. Given the original GNN embeddings eᵤ^{l-1}, eᵢ^{l-1} in Equation (2), and user/item centroids from l−1 layer, GNN model processor 104 may use the attention mechanism to compute output vectors according to the following Equation (10):

$$\begin{matrix}{{e}^{′}}_{u}^{( l )} = {\sum }_{k = 1}^{K} {a}_{k}^{( l - 1 )} {c}_{k}^{( l - 1 )} , and {a}_{k}^{( l - 1 )} = ATTEND ( {e}_{u}^{( l - 1 )} , {c}_{k}^{( l - 1 )} ) , \\ {{e}^{′}}_{u}^{( l )} = {\sum }_{k = 1}^{K} {b}_{k}^{( l - 1 )} {d}_{k}^{( l - 1 )} , and {b}_{k}^{( l - 1 )} = ATTEND ( {e}_{i}^{( l - 1 )} , {d}_{k}^{( l - 1 )} ) ,\end{matrix} \qquad ( 10 )$$

where eᵤ^{′(l)} and eᵢ^{′(l)} are cluster-aware representations of user u and item i in the l-th layer, respectively. These cluster-aware representations compactly summarize the topological information of all users and items, which should contain long-range messages in graphs. ATTEND(·) may be any function that outputs a scalar attention score aₖ ^{(l)} or bₖ^{(l)}. For example, the scaled dot-product as described by Ashish Vaswani, Noam Shazeer, Niki Parmar, Jakob Uszkoreit, Llion Jones, Aidan N Gomez, Lukasz Kaiser, and Illia Polosukhin in the 2017 paper titled “Attention is all you need” in NeurIPS. 5998-6008, the entire contents of which are incorporated herein by reference, may be used for ATTEND(·). Notably, existing GNNs typically use the attention mechanism for local aggregation. Here, non-limiting embodiments or aspects of the present disclosure may extend the attention mechanism for non-local aggregation from user/item centroids.

In Equation (10), a single attention is performed to compute cluster-aware user and item embeddings. Non-limiting embodiments or aspects of the present disclosure may further improve GNNs by using multiple OT heads for attention operators. Following the k-Means clustering described herein with respect to Equation (6), GNN model processor 104 may project users' GNN embeddings into H separate subspaces {ƒ_{θ}^{h}(eᵤ_{₁}), ƒ_{θ}^{h}(eᵤ_{₂}), . . . , ƒ_{θ}^{h}(eᵤ_{_{N}})}ₕ₌₁^{H} ⊂ [symbol] ^{d} via H separate functions (e.g., ƒ_{θ}^{h}(eᵤ_{ᵢ})=W^{h}eᵤ_{ᵢ}, where W^{h} ∈ [symbol] ^{d×d} is the weight for head h). Similarly, GNN model processor 104 may compute H cluster-aware user representations {eᵤ^{′(1,l)}, . . . , eᵤ^{′(H,l)}}⊂ [symbol] ^{d} and items {eᵢ^{′(1,l)}, . . . , eᵢ^{′(H,l)}}⊂ [symbol] ^{d}, where each element is calculated according to Equation (10). GNN model processor 104 may concatenate the multi-head cluster-aware representations according to Equation (11):

$$\begin{matrix}{e}_{u}^{′ ( l )} = CONCAT ( {e}_{u}^{′ ( 1 , l )} , … , {e}_{u}^{′ ( H , l )} ) \cdot {W}_{u}^{( l )} , \\ {e}_{i}^{′ ( l )} = CONCAT ( {e}_{i}^{′ ( 1 , l )} , … , {e}_{i}^{′ ( H , l )} ) \cdot {W}_{i}^{( l )} ,\end{matrix} \qquad ( 11 )$$

where {eᵤ^{(l)}, eᵢ^{(l)}}∈ [symbol] ^{d} are multi-head cluster aware representations or attention operators for user u and item i, respectively, and {Wᵤ^{(l)}), Wᵢ^{(l)}}∈ [symbol] ^{Hd×d} are learned weights, which project multi-head attentions of users and items to d-dimensional space.

Because eᵤ^{(l)}and eᵢ^{(l)} in Equation (2) collect local messages from neighbors, while eᵤ^{′(l)} and eᵢ^{i(l)} in Equation (11) capture non-local messages from centroids, GNN model processor 104 may mix the local and non-local attention by using mixup techniques according to the following Equation (12):

$$\begin{matrix}{{e}^{″}}_{u}^{( l )} = {λ}^{( l )} {e}_{u}^{( l )} + ( 1 - {λ}^{( l )} ) {e}_{u}^{′ ( l )} , \\ {{e}^{″}}_{i}^{( l )} = {λ}^{( l )} {e}_{i}^{( l )} + ( 1 - {λ}^{( l )} ) {e}_{i}^{′ ( l )} ,\end{matrix} \qquad ( 12 )$$

where eᵤ^{″(l)} and eᵤ^{″(l)} are the final representations for downstream tasks, λ^{(l)}∈[0, 1] is the l-hop mixing coefficient that is sampled from a uniform distribution (e.g., a Beta distribution, where Beta(a, a) is a uniform distribution when a=1, Bell-shaped when a>1, and Bimodal when a<1): λ^{(l)}˜Uniform(0,1), for each hop l. By doing so, the mixup extends the training distribution by linear interpolations of embedding manifolds, which is shown to increase their generalization ability. For example, GNN model processor 104 may generate a mixed embedding based on the attention operator and the aggregated node data from the first node and the at least one second node comprising the neighbor node of the first node, a mixed embedding, and the relational data may be generated based on the mixed embedding.

As shown in FIG. 4, at step 410, process 400 includes generating relational data. For example, GNN model processor 104 may generate relational data corresponding to a relation between the first node and at least one third node comprising a non-neighbor node of the first node using the attention operator. As an example, GNN model processor 104 may plug the user/item embeddings (e.g., eᵤ^{″(l )}and eᵤ^{″(l)}) from Equation (12) into Equations (3) and (4) to predict relational data or preference scores corresponding to relations between nodes (e.g., between the first node and at least one third node comprising a non-neighbor node of the first node using the attention operator).

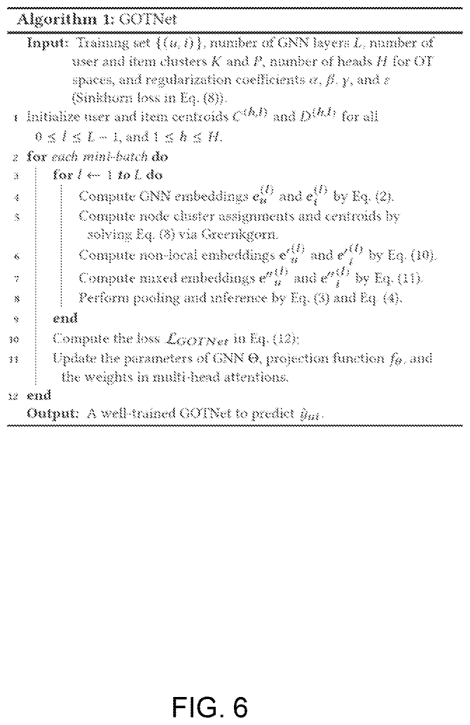

Referring now also to FIG. 6, which is a diagram including pseudocode for training non-limiting embodiments or aspects of a GOTNet, GNN model processor 104 may jointly learn GNNs and k-Means in one unified model. As an example, GNN model processor 104 may combine the losses in Equations (5) and (9) to optimize an overall objective according to Equation (13):

$${ℒ}_{GOTNet} = {ℒ}_{BPR} + β \cdot {\sum }_{l = 0}^{L - 1} {\sum }_{h = 1}^{H} {ℒ}_{uOT}^{( h , l )} + γ \cdot {\sum }_{l = 0}^{L - 1} {\sum }_{h = 1}^{H} {ℒ}_{iOT}^{( h , l )} \qquad ( 13 )$$

where [symbol] _{uOT}^{(h,l)} and [symbol] _{iOT}^{(h,l)}. are the Sinkhorn losses for users and items for h-head in the hop l, respectively, and β and γ are their corresponding regularized coefficients. This loss is differentiable with respect to all variables. In such an example, GNN model processor 104 may use the loss computed in Equation (13) to update the parameters of the GNN θ, the projection function ƒ_{θ}, and the weights in the multi-head attentions.

Accordingly, a GOTNet according to non-limiting embodiments or aspects may be built on top of GNNs while keeping the major network architectures unchanged, enabling the GOTNet to be model-agnostic and seamlessly applied to any GNN, such as PinSage, NGCF, and LightGCN. For example, if β=γ=0 is set in Equation (13) and mixup coefficients λ^{(l)}=1 are set in Equation (12), a GOTNet according to non-limiting embodiments or aspects may be similar to the GNNs. Moreover, a GOTNet according to non-limiting embodiments or aspects may be fully compatible with existing regularization & normalization techniques (e.g., PairNorm, DropEdge, etc.), which are commonly used for deep GNNs.

Compared to existing GNNs, GOTNets according to non-limiting embodiments or aspects may involve an extra cost: k-Means clustering via Optimal Transport in Equation (9). For clustering users, the cost of Greenkhorn is O(NKd), where N denotes the number of users, K is the number of centroids, and d is the GNN embedding size. Similar complexity can be obtained for clustering items. In practice, the values of Kand d may often be very small. Therefore, the complexity of GOTNet may remain the same order as existing GNNs.

A GOTNet according to non-limiting embodiments or aspects may be different from Cluster-GCN, even though they both use clustering techniques. Cluster-GCN uses graph clustering to obtain a set of subgraphs and performs graph convolutions within these subgraphs. In contrast, a GOTNet according to non-limiting embodiments or aspects may perform clustering on GNN embeddings to exploit long-range dependencies, which may be more relevant to recent fast Transformers with clustered attentions, in which the queries are grouped into clusters, and attention is only computed once per cluster. This significantly reduces the complexity of attention mechanisms for large-scale data.

As shown in FIG. 4, at step 412, process 400 includes generating a recommendation based on relational data. For example, GNN model processor 104 may generate a recommendation based on the relational data. As an example, GNN model processor 104 may recommend one or more nodes according to the relational data or preference scores corresponding to the relations between the nodes. For example, GNN model processor may recommend one or more items to a user according to the relational data or preference scores corresponding to the relations between the user and the one or more items. As an example, GNN model processor 104 may recommend a ranked list of items from Iᵤ⁻ that are predicted to be of interest to the user u∈U according to a ranking (e.g., highest to lowest, etc.) of the preference scores corresponding to the relations between the nodes.

As shown in FIG. 4, at step 414, process 400 includes providing a recommendation. For example, GNN model processor 104 may provide the recommendation. As an example, GNN model processor 104 may transmit the recommendation to user device 106. For example, the first node may correspond to a first user, and the historical data may comprise a plurality of first user-item pairings corresponding to historical transactions of the first user (e.g., items purchased, rented, viewed, experienced, and/or queried by the user). In such an example, GNN model processor 104 may generate a first recommendation for the first user based on the relational data, the recommendation comprising an item and/or a ranked list of items not directly associated with the first user in the historical data (e.g., an item not purchased, rented, viewed, experienced, and/or queried by the user, etc.); and/or transmit the first recommendation to a device of the first user (e.g., user device 106, etc.).

Accordingly, non-limiting embodiments or aspects enable capturing long-range dependencies without increasing the depths of GNNs, which largely reduces the bottleneck effects (e.g., overfitting and oversmoothing, and gradient vanishing) in training deep GNNs; performing k-Means clustering on embedding space to obtain compact centroids and using non-local operators to measure node-centroid attentions, which achieves linear complexity to collect long-range messages; fully differential k-Means clustering by casting it to an equivalent OT task, which can be solved efficiently by greedy Sinkhorn algorithm and enables the parameters of GNNs and k-Means to be jointly optimized at scale; and a model-agnostic GOTNet that can be applied to any GNN.

### Experiments

Experiments are conducted on four benchmark datasets: Movielens-1M, Gowalla, Yelp-2018, and Amazon-Book. Movielens-1M is a widely used movie rating dataset that contains one million user-movie ratings. The rating scores are transformed into binary values, indicating whether a user rated a movie. Gowalla is obtained from the location-based social website Gowalla, where users share their locations by checking-in. Yelp-2018 is released by the Yelp 2018 challenge, where local business like restaurants are viewed as items. Amazon-Book contains a large corpus of user reviews, ratings, and product metadata, collected from Amazon.com. The largest category Books is chosen.

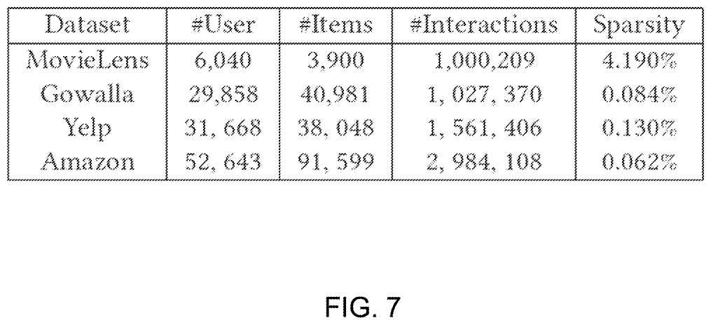

FIG. 7 is a table that briefly summarizes statistics of datasets on which experiments are conducted. The same strategy as NGCF and LightGCN is followed to split the train/valid/test data sets. Due to the sparsity of datasets, the 10-core setting of the user-item graphs is used to ensure that all users and items have at least ten interactions.

For each dataset, 80% of historical interactions of each user are selected to generate the training set, and the remaining is treated as the test set. From the training set, 10% of interactions are randomly selected as a validation set to tune hyper-parameters. For each observed user-item interaction, it is treated as a positive instance, and the ranking triplets are conducted by sampling from negative items that the user did not consume before.

The experiments compare a GOTNet according to non-limiting embodiments or aspects to the following baselines: BPR-MF (a classic model that seeks to optimize the Bayesian personalized ranking loss; matrix factorization is employed as its preference predictor); NeuMF (NeuMF learns nonlinear interactions between user and item embeddings via a multi-layer perceptron as well as a generalized matrix factorization); PinSage (PinSage designs a random-walk based sampling method to sample neighbors for each node and then combines graph convolutions to compute node embeddings); NGCF (a method that explicitly learns the collaborative signal in the form of high-order connectivities by performing embedding propagation from user-item graphs); LightGCN (LightGCN is a simplified version of NGCF by removing the feature transformation and nonlinear activation, which achieves the state-of-the-art performance); Geom-GCN (a model that explores to capture long-range dependencies by using bi-level geometric aggregations from nodes. There are three variants of Geom-GCN, the best results are reported; by choosing PinSage, NGCF, and LightGCN as its backbones, their corresponding Geom-GCNs are provided); and NL-GCN (a recently proposed non-local GNN framework that uses efficient attention-guided sorting mechanism, which enables non-local aggregation through convolutions; PinSage, NGCF, and/or LightGCN can be selected as its backbones).

Widely used Recall@kand NDCG@kare chosen as evaluation metrics for the experiments. For fair comparison, default Recall@20 and NDCG@20 are computed by the all-ranking protocol. The average results of ten independent experiments are reported for both metrics.

For all models, the embedding size dof users and items (e.g., Equation. (1)) is searched within {16, 32, 64, 128}. For all baselines, their hyper-parameters are initialized as in their original settings and are then carefully tuned to attain optimal performance. For the GNN modules inside Geom-GCN, NL-GCN, and GOTNet, the same hyper-parameters as their backbones are used, such as batch size, learning rate in Adam optimizer, etc. For GOTNets, the clustering loss regularizers are set as β=γ=0.01, the entropy regularizer as ε=0.01, the number of user/item clusters: K≈0.01 N and P≈0.01M, and the number of head H=1. The parameter sensitivity of GOTNet is addressed herein below.

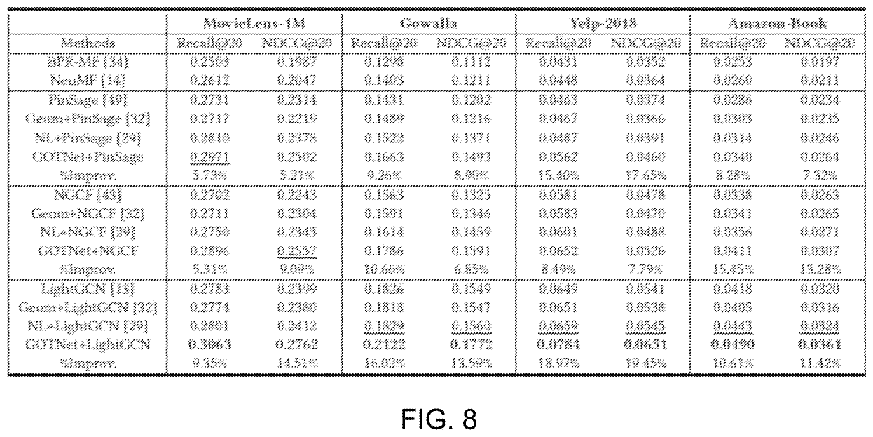

FIG. 8 is a table that summarizes performance comparisons of different models. The best performance is highlighted in boldface and the second best is underlined. Non-limiting embodiments or aspects of a GOTNet consistently yield the best performance across all datasets. From FIG. 8, the following observations and conclusions may be made.

Compared with factorization-based methods BPR-MF and NeuMF, GNN-based methods (e.g., PinSage, NGCF, and LightGCN) generally achieve better performance for all cases. This greatly suggests the benefits of exploiting high-order proximity between users and items in the bipartite graph. As much more informative messages being aggregating from neighbors, GNN-based methods are capable of inferring explicit or implicit correlations among neighbors via graph convolutions.

Among GNN-based methods, non-local GNN methods (e.g., Geom-GCNs, NL-GCNs, and GOTNets) perform better than vanilla GNNs. This is because non-local operators allow capturing long-range dependencies from distant nodes, while original graph convolutional operators only aggregate information from local neighbors. In addition, NL-GCNs is slightly better than Geom-GCNs. Geom-GCNs requires pre-trained node embedding to construct latent spaces, which may be not task-specific. In contrast, NL-GCNs employs calibration vectors to refine non-local neighbors, which can be joint trained with GNNs, leading to better results than Geom-GCNs. Nevertheless, NL-GCNs only calibrate the output embeddings of GNNs, which lacks adaptability.

GOTNets consistently outperforms NL-GCNs by a large margin on all datasets. Comparing to NL-GCNs, GOTNets have on average 13.74% improvement in terms of Recall@20, and over 14.75% improvements with respect to NDCG@20. These improvements are attributed to multi-heads node-centroid attentions and attention mixups of non-limiting embodiment or aspects of the present disclosure. Through clustering users and items in multiple OT spaces, GOTNets augment both user-to-user and item-to-item correlations, which provide a better way to help users explore their inventory (e.g., people who like items also like items in same group.). Also, attention mixups extend the distribution of training data by linear interpolations of local and non-local embeddings, which largely improves the generalization and robustness of GNNs.

It is noticed that a GOTNet according to non-limiting embodiments or aspects of the present disclosure can generalize both Geom-GCNs and NL-GCNs by relaxing certain constraints: If cluster-aware centroid vectors are detached from Sinkhorn loss, these vectors have the potential to serve as calibration vectors in NL-GCNs; if the number of clusters is set to be equal to the number of nodes, GOTNet is able to measure node-node attentions as Geom-GCNs do.

In terms of time complexity, the time elapsed under same hardware for training each epoch of LightGCN, Geom-GCN, NL-GCN, and GOTNet are about 370s, 810s, 480s, and 510s for Amazon dataset, respectively. Overall, the experimental results demonstrate the superiority of a GOTNet according to non-limiting embodiments or aspects of the present disclosure. Specifically, a GOTNet according to non-limiting embodiments or aspects of the present disclosure generally outperforms all baselines and has comparable complexity to state-of-the-art GNNs.

The benefits of non-local aggregation may be further studied from two aspects: (1) over-smoothing and (2) data sparsity. In the interest of brevity, only the results of LightGCN and its variants are provided, while having similar trends for both PinSage and NGCF.

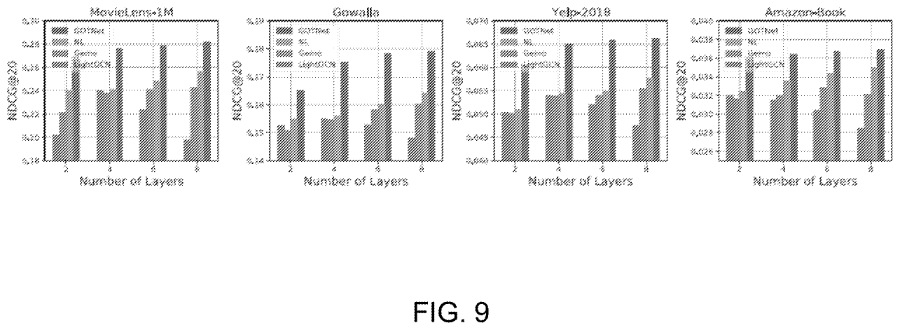

The over-smoothing phenomenon exists when training deep GNNs. To illustrate this influence, experiments with varying number of layers L within {2, 4, 6, 8} are conducted. FIG. 9 is graphs that present results in terms of NDCG@20 of different GNNs with varying number of layers. It is observed that the peak performance of LightGCN is achieved when stacking 2 or 4 layers, but increasing depth causes performance degradation. In contrast, non-local GNNs (e.g., Geom-GCN, NL-GCN, GOTNet) continue to benefit from deeper architectures. Specifically, a GOTNet according to non-limiting embodiments or aspects of the present disclosure clearly outperforms Geom-GCN and NL-GCN for all datasets. A reason is that GOTNet explicitly adopts a mixture of local and non-local aggregations to inhibit or prevent all node representations converging to the same values even with deeper structures. Additionally, multi-head projections allow users and items to have distinguishable representations in multiple different spaces, which makes node representations less similar and alleviates the over-smoothing problem.

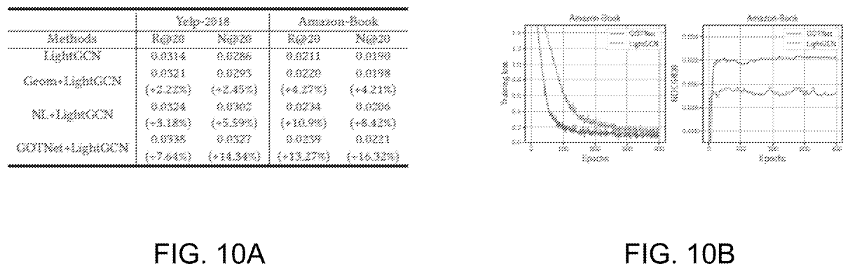

As discussed herein, graph convolutions are essentially local operators, which give an advantage to high-degree nodes to collect enough information from their neighbors. However, many real-world graphs are often long-tailed and sparse where a significant fraction of nodes have low degrees. For these tail nodes, GNNs only aggregate messages from a small number of neighbors, which can be biased or underrepresented. Towards this end, the effectiveness of non-local GNNs to sparse recommendations is investigated. For this purpose, focus is on the users and items that have at least five interactions, but less than ten interactions. FIG. 10A is a table that shows performance of different models for sparse recommendation for the Yelp and Amazon datasets. Similar trends are seen for the other datasets and are omitted here in the interest of brevity. As can be seen, non-local methods perform better than Light-GCN, verifying that non-local mechanisms facilitate the representation learning for inactive users/items. For example, GOTNet reaches a relative improvement over LightGCN by an average of 10.46% and 15.33% in terms of Recall and NDCG, respectively. These comparisons demonstrate that non-local node-centroid attentions used in GOTNet are able to capture long range dependencies. For inactive users/items, their clusters can identify groups of users/items that appear to have similar representations. As such, more meaningful messages can be passed via node-centroid attentions, rather than their sparse neighbors. FIG. 10B is graphs of training curves of training loss and testing NDCG for different models. As shown in FIG. 101B, LightGCN attains stable training losses but produces fluctuations in the stage of test. Conversely, GOTNet is more robust against the issue of overfitting.

The parameter sensitivity of GOTNet with respect to the following hyper-parameters: two regularizer parameters {β, λ} in Equation (13), entropy regularizer ε in Equation (9), and the number of users/items clusters K and P, and the number of heads H. The Amazon dataset is mainly used for these hyper-parameter studies.

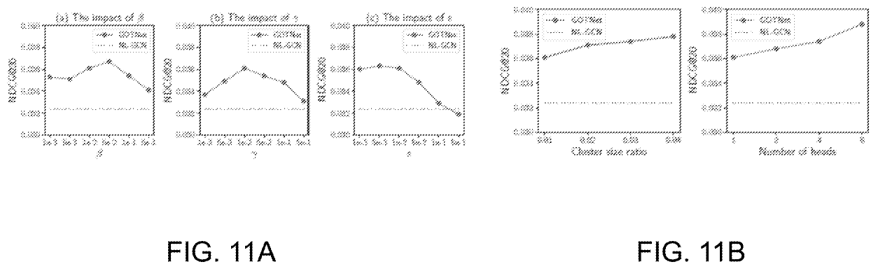

Here, the performance sensitivity of GOTNet with different regularizers {β, γ, ε} is analyzed. FIG. 11A is graphs that show parameter sensitivity of a GOTNet according to non-limiting embodiments or aspects. As shown in FIG. 11A, the performance by changing one parameter while fixing the rest as 0.01 of GOTNet is relatively insensitive to β and γ, and achieves the best performance with β=5e⁻² and γ=1e⁻². It is also found that the non-zero choices of μ and γ generally outperform NL-GCNs, indicating the contribution of the clustering losses in non-limiting embodiments or aspects of GOTNets. Further shown in FIG. 11A is the impact of ε in Sinkhorn loss. The choice of ε is matters in OT solvers. Typically, performance gets closer to true Optimal Transport plan when ε get smaller (e.g., ε←0). Sinkhorn's algorithm, however, uses more iterations to converge, leading to more running time. It is observed that setting ε within [5e⁻³, 5e⁻²] is a good trade-off.

Experiments are also conducted to determine whether using large cluster sizes and more heads are beneficial to final results. FIG. 11B is graphs that show impacts of clustering sizes and attention heads. As shown in FIG. 11B, varying the clustering size of users and items

$$r = \frac{K}{N} = P / M$$

from 0.01 to 0.04, and the number of heads H within, increases performance with larger cluster sizes, as well as more heads. Such results are expected since higher cluster sizes and more heads lead to more discriminative representations of users/items.

Accordingly, non-limiting embodiments or aspects of the present disclosure provide simple yet effective systems, methods, and computer program products to improve the ability of capturing long-range dependencies. Instead of training deep architectures, non-limiting embodiments or aspects combine: k-Means clustering and GNNs to obtain compact centroids, which can be used to deliver long-range messages via non-local attentions. The extensive experiments suggest that a GOTNet according to non-limiting embodiments or aspects can empower many existing GNNs.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method for determining long-range dependencies using a non-local graph neural network, comprising:
receiving, with at least one processor, a dataset comprising historical data;
generating at least one layer of a graph neural network by generating, with at least one processor, graph convolutions to compute node embeddings for a plurality of nodes of the dataset, the graph convolutions generated by aggregating node data from a first node of the dataset and node data from at least one second node comprising a neighbor node of the first node;
clustering, with at least one processor, the node embeddings to form a plurality of centroids, each centroid corresponding to a graph-level representation of a plurality of node embeddings, the plurality of centroids comprising a first centroid;
determining, with at least one processor, an attention operator for at least one node-centroid pairing, the at least one node-centroid pairing comprising the first node and the first centroid, the attention operator configured to measure a similarity between the first node and the first centroid; and
generating, with at least one processor, relational data corresponding to a relation between the first node and at least one third node comprising a non-neighbor node of the first node using the attention operator.

2. The method of claim 1, further comprising:
generating, with at least one processor, a recommendation based on the relational data.

3. The method of claim 1, wherein the first node corresponds to a first user, wherein the historical data comprises a plurality of first user-item pairings corresponding to historical transactions of the first user, wherein the method further comprises:
generating, with at least one processor, a first recommendation for the first user based on the relational data, the first recommendation comprising an item not directly associated with the first user in the historical data; and
transmitting, with at least one processor, the first recommendation to a device of the first user.

4. The method of claim 1, wherein a plurality of layers of the graph neural network are generated, wherein the clustering is performed in between each layer of the graph neural network generated, and each subsequent layer is generated using at least one centroid formed at a preceding layer.

5. The method of claim 1, wherein the attention operator includes a multi-headed attention.

6. The method of claim 1, further comprising:
generating, with at least one processor, based on the attention operator and the aggregated node data from the first node and the at least one second node comprising the neighbor node of the first node, a mixed embedding, wherein the relational data is generated based on the mixed embedding.

7. A system for determining long-range dependencies using a non-local graph neural network, comprising at least one processor programmed and/or configured to:
receive a dataset comprising historical data;
generate at least one layer of a graph neural network by generating graph convolutions to compute node embeddings for a plurality of nodes of the dataset, the graph convolutions generated by aggregating node data from a first node of the dataset and node data from at least one second node comprising a neighbor node of the first node;
cluster the node embeddings to form a plurality of centroids, each centroid corresponding to a graph-level representation of a plurality of node embeddings, the plurality of centroids comprising a first centroid;
determine an attention operator for at least one node-centroid pairing, the at least one node-centroid pairing comprising the first node and the first centroid, the attention operator configured to measure a similarity between the first node and the first centroid; and
generate relational data corresponding to a relation between the first node and at least one third node comprising a non-neighbor node of the first node using the attention operator.

8. The system of claim 7, wherein the at least one processor is programmed and/or configured to:
generate a recommendation based on the relational data.

9. The system of claim 7, wherein the first node corresponds to a first user, wherein the historical data comprises a plurality of first user-item pairings corresponding to historical transactions of the first user, wherein the at least one processor is programmed and/or configured to:
generate a first recommendation for the first user based on the relational data, the first recommendation comprising an item not directly associated with the first user in the historical data; and
transmit the first recommendation to a device of the first user.

10. The system of claim 7, wherein a plurality of layers of the graph neural network are generated, wherein the clustering is performed in between each layer of the graph neural network formed, and each subsequent layer is generated using at least one centroid generated at a preceding layer.

11. The system of claim 7, wherein the attention operator includes a multi-headed attention.

12. The system of claim 7, wherein the at least one processor is programmed and/or configured to:
generate, based on the attention operator and the aggregated node data from the first node and the at least one second node comprising the neighbor node of the first node, a mixed embedding, wherein the relational data is generated based on the mixed embedding.

13. A computer program product for determining long-range dependencies using a non-local graph neural network, comprising at least one non-transitory computer-readable medium including program instructions that, when executed by at least one processor, cause the at least one processor to:
receive a dataset comprising historical data;
generate at least one layer of a graph neural network by generating graph convolutions to compute node embeddings for a plurality of nodes of the dataset, the graph convolutions generated by aggregating node data from a first node of the dataset and node data from at least one second node comprising a neighbor node of the first node;
cluster the node embeddings to form a plurality of centroids, each centroid corresponding to a graph-level representation of a plurality of node embeddings, the plurality of centroids comprising a first centroid;
determine an attention operator for at least one node-centroid pairing, the at least one node-centroid pairing comprising the first node and the first centroid, the attention operator configured to measure a similarity between the first node and the first centroid; and
generate relational data corresponding to a relation between the first node and at least one third node comprising a non-neighbor node of the first node using the attention operator.

14. The computer program product of claim 13, wherein the program instructions cause the at least one processor to:
generate a recommendation based on the relational data.

15. The computer program product of claim 13, wherein the first node corresponds to a first user, wherein the historical data comprises a plurality of first user-item pairings corresponding to historical transactions of the first user, wherein the program instructions cause the at least one processor to:
generate a first recommendation for the first user based on the relational data, the first recommendation comprising an item not directly associated with the first user in the historical data; and
transmit the first recommendation to a device of the first user.

16. The computer program product of claim 13, wherein a plurality of layers of the graph neural network are generated, wherein the clustering is performed in between each layer of the graph neural network generated, and each subsequent layer is generated using at least one centroid formed at a preceding layer.

17. The computer program product of claim 13, wherein the attention operator includes a multi-headed attention.

18. The computer program product of claim 13, wherein the program instructions cause the at least one processor to:
generate, based on the attention operator and the aggregated node data from the first node and the at least one second node comprising the neighbor node of the first node, a mixed embedding, wherein the relational data is generated based on the mixed embedding.
